(19) United States
(12) Patent Application Publication
(10) Pub. No.: US 2010/0064917 A1
(43) Pub. Date: Mar. 18, 2010

(54) PRINTING MACHINE AND CORRESPONDING METHOD

(75) Inventors: Alain Blanchard, Gouvieux (FR); Roger Stanchina, Chantilly (FR); Bernard Beranger, Gouvieux (FR); Antoine Chevalier, Gouvieux (FR); Pascal Ollivier, Verneuil en Halatte (FR)

Correspondence Address: Davidson, Davidson & Kappel, LLC, 485 7th Avenue, 14th Floor, New York, NY, 10018, US

(73) Assignee: Goss International Montataire SA, Montataire (FR)

(21) Appl. No.: 12/516,344

(22) PCT Filed: Nov. 24, 2006
(86) PCT No.: PCT/FR07/01813

§ 371 Date: Sep. 11, 2009

(30) Foreign Application Priority Data
Nov. 24, 2006 (FR) 0610318

(51) Int. Cl. B41F 13/56; B41F 33/00

(52) U.S. Cl. 101/226; 101/483

(57) ABSTRACT

A rotary printing press is provided. The rotary printing press includes a continuous printing web of material to be printed, at least one printing unit for printing on the printing web, and a cutting device for cutting the web printed by the printing unit. The rotary printing press further includes a traction device located downstream of the furthest downstream printing unit and upstream of the cutting device. The traction device is for applying a predetermined mechanical tension to the printed web discharged from the furthest downstream printing unit and the printing web is a coated paper web. A method for printing is also provided.

The present invention relates to a rotary printing press of the type including a continuous printing web of material to be printed, at least one printing unit for printing on the printing web and a cutting device for cutting the web which is printed by the printing unit.

### BACKGROUND OF THE INVENTION

There are known in the prior art rotary printing presses, which include at least one printing unit which is provided with a pair of printing rollers, and a cutting device for cutting the web which is printed by the printing unit.

Known printing presses further include a dryer which is provided between the last printing unit and the cutting device. The dryer is used in order to dry the ink which is provided on the printed web in order to prevent the sheets from becoming marked in the cutting device.

### SUMMARY OF THE INVENTION

The presence of a dryer involves a great spatial requirement for the printing press and increases the cost of the printing press.

An object of the present invention is to overcome these disadvantages and to provide a printing press which has a reduced spatial requirement.

Furthermore, known rotary printing presses are not capable of printing on high-quality paper. Another object of the invention is to provide a printing press which allows high-quality printed products to be produced for given expenditure.

The present invention provides a printing press including a continuous printing web of material to be printed, at least one printing unit for printing on the printing web, a cutting device for cutting the web printed by the printing unit and a traction device located downstream of the furthest downstream printing unit and upstream of the cutting device, the traction device being suitable for applying a predetermined mechanical tension to the printed web which is discharged from the furthest downstream printing unit, the printing web being a coated paper web.

According to preferred specific embodiments, the printing press may include one or more of the following features:
the press is suitable for conveying the printed web so as to be freely suspended and in ambient air over the entire travel between the printing unit furthest downstream and the traction device;
the press is suitable for conveying the printed web in ambient air over the entire travel between the traction device and the cutting device;
the press includes a device for drying the printed web, in particular an infrared radiation drying device, which is provided downstream of the traction device and upstream of the cutting device;
the traction device includes two traction elements, each having a traction surface which is suitable for moving into contact with a face of the printed web so as to apply the predetermined mechanical traction to the printed web;
the press includes means for providing a liquid which repels ink at least at one traction surface;
the two traction elements include traction surfaces which repel ink;
the two traction elements are traction rollers;
the two traction rollers are provided with spacing from each other, defining a substantially S-like travel for the printed web;
the two traction rollers are provided one behind the other over the travel of the printed web, and the traction device includes two clamping rollers, each of which is provided facing one of the traction rollers, the clamping rollers having a diameter which is different from the diameter of the traction rollers, and a clamping roller and a traction roller being suitable for clamping the printed web therebetween, respectively;
the two traction rollers are provided facing each other;
each of the two traction elements is suitable for moving into contact with one of the two opposing faces of the printed web;
at least one of the traction rollers includes openings in the outer surface thereof, and the traction device is provided with a pressure reduction device which is suitable for producing a reduced pressure in those openings;
the traction device is provided with a device for cleaning the traction surface of at least one of the traction rollers;
the cleaning device includes a cleaning bar in contact with the traction surface;
the cleaning device includes a first cleaning roller, the surface of which is suitable for moving into rolling contact with a traction roller, the surface of the first cleaning roller attracts ink and the cleaning device includes means for removing the ink from the surface of the cleaning roller;
the cleaning roller is movable between a cleaning position, in which it is in contact with the associated traction roller and a washing position, in which it is in contact with a device for washing the cleaning roller;
the cleaning device includes a second cleaning roller which is suitable for moving into contact with the same traction roller as the first cleaning roller, and those two cleaning rollers are suitable for alternately moving into contact with the traction roller;
the traction rollers and the clamping rollers are movable between a traction position of the printed web and a cleaning position, and the press is suitable for moving a pair comprising a traction roller and a clamping roller into the cleaning position thereof while the other pair comprising a traction roller and a clamping roller is in the traction position thereof;
the traction elements include traction bars which extend across the printed web;
the press further includes an auxiliary device which is provided between the printing unit furthest downstream and the cutting device, the auxiliary device includes at least one support roller which is provided with a support surface for the printed web, and the auxiliary device includes means for producing a cushion of air between the support surface and the printed web;
the printing unit includes a reservoir of ink which contains ink and which is suitable for printing on the printing web;
the ink is waterless ink;
the ink is desiccative ink or bi-component ink; and
the coated paper of the printing web is coated paper having a coating of kaolin or chalk.
The present invention further provides a printing method of the type comprising the following steps:

a) printing on a printing web, forming a printed web,

b) cutting the printed web into printed sheets,

c) producing a predetermined mechanical tension in the printed web before the cutting operation by means of a printing press according to any one of the preceding claims, and in that

d) the printing web is a coated paper web, in particular comprising a coating of kaolin or chalk.

### BRIEF DESCRIPTION OF THE DRAWINGS

The invention will be better understood from a reading of the following description which is given purely by way of example and with reference to the appended drawings, in which:

FIG. 1 is a schematic side view of a printing press according to the invention;

FIG. 2 is a view corresponding to the view of FIG. 1 of a variant of a printing press according to the invention;

FIG. 3 is a perspective view of a detail of a traction device according to a first embodiment of the invention;

FIGS. 4 and 5 are detailed views corresponding to the view of FIG. 3 of the second and third embodiments of a traction device according to the invention;

FIGS. 6 and 7 are side views of the fourth and fifth embodiments of a traction module according to the invention;

FIGS. 8A to 8C are side views of a detail of a traction module according to a sixth embodiment of the invention during different operating steps;

FIG. 9 is a sectioned view of a traction roller of a traction module according to a seventh embodiment of the invention;

FIG. 10 is a schematic side view of a detail of a traction module according to an eighth embodiment;

FIG. 11 is a plan view of the detail of FIG. 10;

FIG. 12 is a schematic side view of a printing press according to a second variant, comprising an auxiliary device of the printed web; and

FIGS. 13 and 14 are side views of the first and second embodiments of the auxiliary device.

### DETAILED DESCRIPTION OF THE PREFERRED EMBODIMENTS

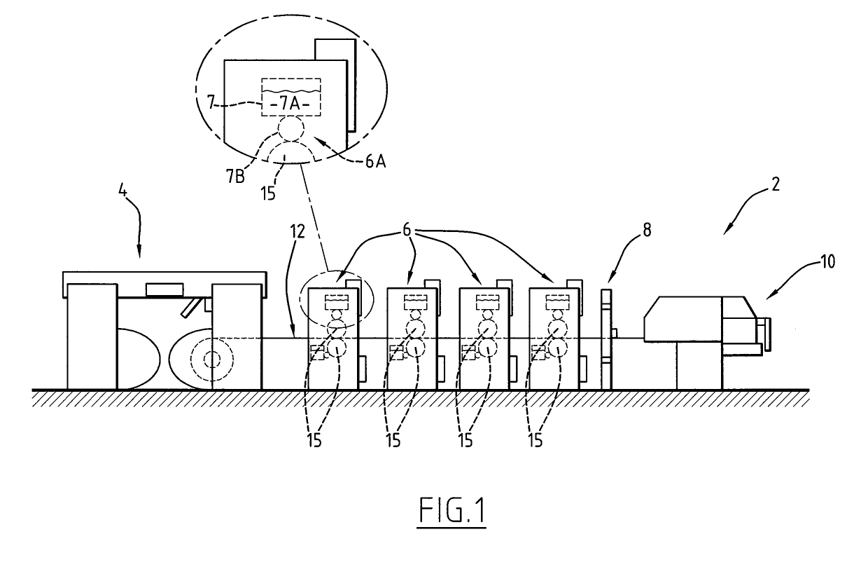

FIG. 1 illustrates a rotary printing press according to the invention generally designated 2.

The printing press 2 includes an unwinding unit 4, four printing units 6, a traction device 8 and a cutting device 10. The printing press 2 may include any number of printing units 6 in theory, from one to n.

Each printing unit 6 includes an inking device 6A which is provided with an ink reservoir 7 comprising ink 7A which is provided in order to print on the web 12. The ink 7A used in the context of the invention will be explained below. Each inking device 6A further includes an ink transfer roller 7B for transferring ink 7A to printing rollers 15 (see below).

The unwinding unit 4 is suitable for unwinding a continuous printing web 12.

According to the invention, the printing web 12 is a coated paper web.

The coated paper is a paper which includes a covering coating, for example, of kaolin or chalk, improving the mechanical or optical properties of the paper.

This paper allows a high-quality printed product to be obtained.

The printing press 2 defines a printing travel path for the web 12 between the unwinding unit 4, through the printing units 6 and the traction device 8, as far as the cutting device 10.

The printing units 6 include printing rollers 15 which are suitable for printing on the web 12.

The cutting device 10 is suitable for cutting the printing web 12 into individual sheets.

The traction device 8 is located downstream of the printing unit 6 furthest downstream and upstream of the cutting device 10. This traction device 8 is suitable for applying a predetermined mechanical tension to the web 12 being discharged from the printing unit 6 furthest downstream.

As shown in FIG. 1, the printing press 2 can convey the printed web 12 so as to be freely suspended and in ambient air over the entire travel between the printing unit 6 furthest downstream and the traction device 8. Furthermore, the printing press 2 is also suitable for conveying the printed web 12 in ambient air over the entire travel between the traction device 8 and the cutting device 10. In this manner, the printing press 2 does not include any dryer and has a low spatial requirement.

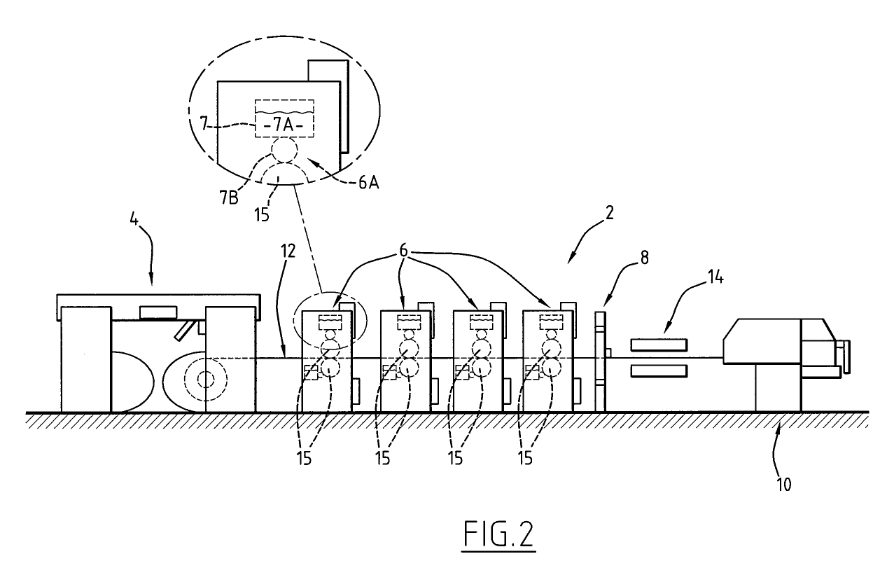

The printing press 2 according to the variant shown in FIG. 2 differs from the printing press 2 shown in FIG. 1 in that there is provided, between the traction device 8 and the cutting device 10, an infrared radiation dryer 14, through which the printed web 12 is moved. The dryer 14 has dimensions which are reduced in relation to dryers from the prior art.

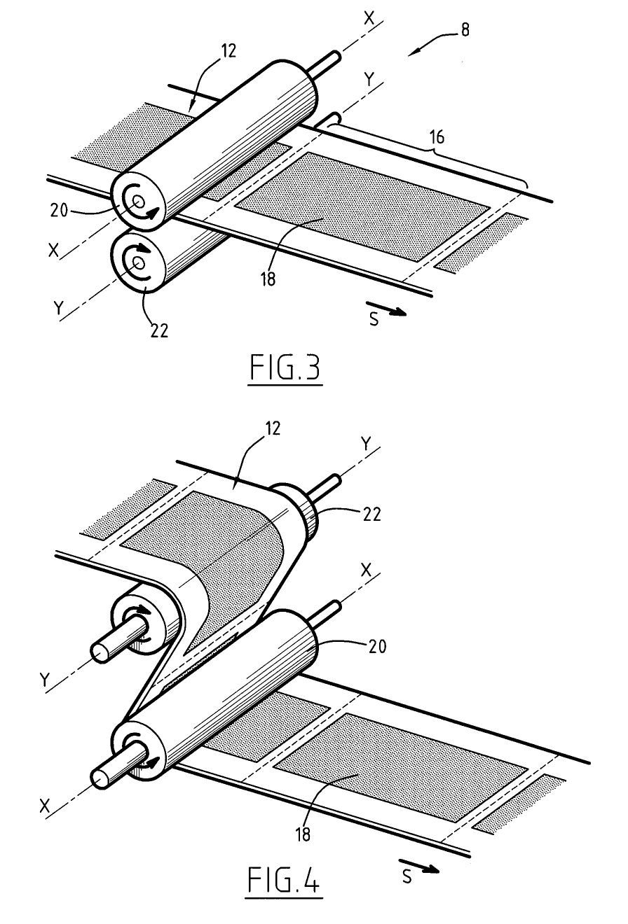

FIG. 3 is a perspective view of a detail of the traction device 8 according to the invention. The printed web 12 is visible. The printed web 12 includes a succession of web portions 16, each of which is of the length of a sheet cut by the cutting device 10. Each portion 16 further includes an image 18 which is printed recto-verso by the printing rollers of the printing units 6. Each portion 16 further includes a non-printed zone which does not include any ink.

The traction device 8 includes two traction rollers 20, 22 which are rotated about the respective axes X-X, Y-Y thereof. Each of the traction rollers 20, 22 moves into contact with one of the surfaces of the printed web 12. The traction rollers 20, 22 are moved in opposite directions and the traction surface thereof moves, at the location of contact with the web 12, in the same direction S as the printed web 12. Each of the traction rollers 20, 22 has an outer surface whose circumference is identical to the length of the web portion 16, which reduces marking. In a variant, the circumference is identical to a multiple of an integer of the length of the portion 16.

The outer surface of each traction roller 20, 22 is produced from an ink-repelling material which is used in order to print the images 18. The traction rollers 20, 22 include, for example, a hydrophilic surface. One of the two rollers is coated with an elastomer. The generatrix of contact of the two rollers ensures gripping in order to draw the paper web 12. The surfaces of the two traction rollers 20, 22 may, for example, include a coating of a silicone-based compound.

The two traction rollers 20, 22 are arranged facing each other in such a manner that the line of contact of the traction roller 20 with the web 12 and the line of contact of the traction roller 22 with the web 12 are located facing each other.

In an advantageous manner, the circumferential speed of the traction rollers 20, 22 is slightly greater than the circumferential speed of the printing rollers of the printing unit 6 furthest downstream in such a manner that the printed web 12 is maintained under traction and therefore a predetermined mechanical tension between the printing unit 6 and the traction device 8.

The traction device 8 allows a paper web to be printed and received in a cutting device 10, such as a horizontal discharge arrangement, without drying the paper web 12 by evaporating solvents from the ink.

The image 18 is printed by the ink 7A contained in the ink reservoir 7. In an advantageous manner, the ink 7A is a desiccative ink or a waterless ink, or a bi-component ink. The drying of the desiccative inks is a combination of a first phenomenon, referred to as “penetration into the support”, and a second phenomenon referred to as “oxido-polymerisation of the lacquers constituted by oils and resins”.

Heat-set inks dry by evaporation of the mineral solvents which are mixed with the resin. UV inks dry by polymerisation of the resin under the action of ultraviolet radiation.

Waterless inks are used with specific printing plates which allow the definition of non-printing zones without using the conventional lithographic method which is based on the rejection of the fatty ink by a previously moistened hydrophilic surface. Using those inks may be envisaged in the same capacity as the conventional desiccative inks set out above and allows a dryer to be dispensed with, or allows the dryer to be configured in a space-saving manner.

FIG. 4 illustrates a detail of a second embodiment of a traction device 8 which differs from FIG. 3 as follows.

Similar elements are referred to with the same reference numerals.

The two traction rollers 20, 22 are arranged with spacing from each other in such a manner that they define a substantially S-like travel of the printed web 12. The S-like arrangement allows an increase in the arc for winding the web on the driven rollers and therefore brings about an increase in the efficacy of the traction module by means of the capstan effect. Another device will have to be associated with that traction module. This device will have to allow the production of downstream tension which is weak but sufficient to bring about upstream tension which is sufficiently high to draw the web out of the last printing group.

FIG. 5 shows a detail of a third embodiment of a traction device 8 according to the invention which differs from the embodiment of FIG. 3 as follows. Similar elements are referred to with the same reference numerals.

The traction module 8 further includes two cleaning devices 30, 32. In this manner, the quality of the image 18 on the printed web 12 is further improved.

The cleaning devices 30, 32 include cleaning bars 34, 36 in permanent contact with the traction surface of the rollers 20, 22. By way of example, the cleaning bars 34, 36 may include a rotating brush which is positioned in contact with the surface to be cleaned or a web of textiles which is brought into contact by a mechanical member. In both cases, the cleaning is facilitated by the action of a solvent. Those techniques are used in particular for cleaning the blankets on rotary offset presses.

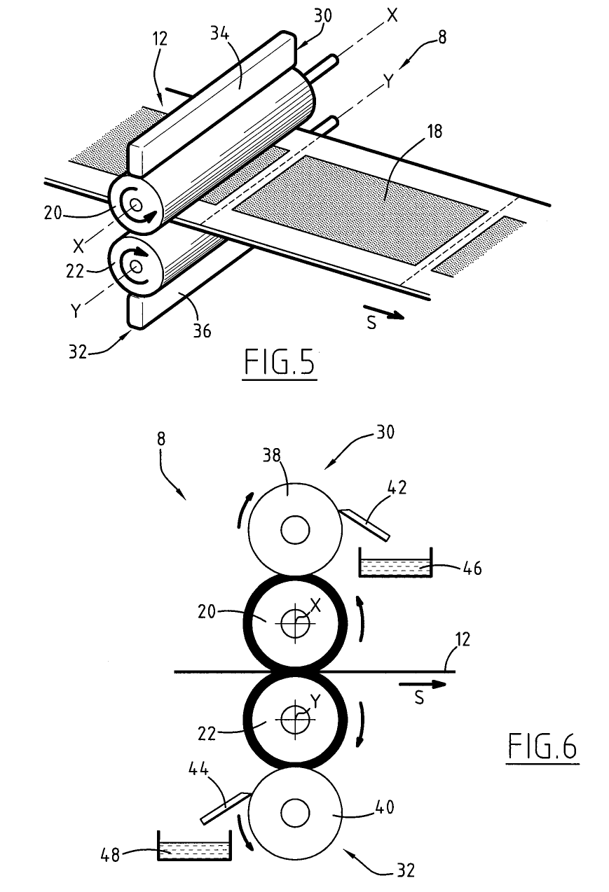

FIG. 6 is a side view of a fourth embodiment of the traction device 8. This embodiment differs from the third embodiment as follows.

The two traction rollers 20, 22 include surfaces which repel ink, such as a coating of a silicone-based compound.

The cleaning device 30 includes a cleaning roller 38 which includes a surface of a material which attracts ink and which is in contact with the surface of the traction roller 20. The cleaning roller 38 is, for example, coated with a porous ceramic material which is intended to be impregnated with ink and, in this manner, has surface properties which promote the transfer of ink. This technique is used in particular to construct ink duct rollers. The cleaning device 30 further includes a doctor blade 42 which is in permanent contact with the surface of the cleaning roller 38 and which conveys the ink removed by the roller 38 towards a collection tank 46.

The cleaning device 32 further includes a cleaning roller 40 which includes a surface of a material which attracts ink, such as a coating of a porous ceramic material which is intended to be impregnated with ink and which, in this manner, has surface properties which promote the transfer of ink. The surface of the roller 40 is in contact with the surface of the traction roller 22. The cleaning device 32 further includes a doctor blade 44 which is in permanent contact with the surface of the cleaning roller 40 and which conveys the ink removed by the rollers 40 towards a collection tank 48.

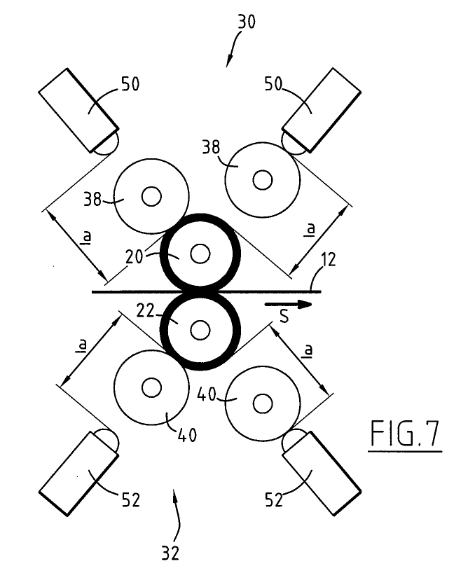

FIG. 7 illustrates a fifth embodiment of the traction device 8 which includes a variant of the cleaning devices 30, 32. Each cleaning device 30, 32 includes two cleaning rollers 38, 40 which attract ink, and, for each of the cleaning rollers 38, 40, a washing device 50, 52.

The washing device 50, 52 is arranged at a distance a from the surface of the associated traction roller 20, 22 which is greater than the diameter of the corresponding cleaning roller 38, 40. Each cleaning roller 38, 40 is movable between a cleaning position, in which it is in contact with the associated traction roller 20, 22, and a washing position, in which it is in contact with the associated washing device 50, 52. The two cleaning rollers 38, 40 of each cleaning device 30, 32 are controlled so as to move into contact alternately with the associated traction roller 20, 22.

In other words, while one of the cleaning rollers 38 is in contact with the traction roller 20, the other cleaning roller 38 is in contact with the washing device 50. Similarly, while one of the cleaning rollers 40 is in contact with the traction roller 22, the other cleaning roller 40 is in contact with the washing device 52. The device described in FIG. 7 has an advantage over the device described in FIG. 6. Supposing that cleaning can, owing to contamination by the washing solvent, temporarily modify the properties of the surfaces of the rollers 20 and 22 (rejection of ink), this operation is carried out, in the case of the device of FIG. 7, on rollers 38 and 40 which are not in contact with the traction rollers 20 and 22.

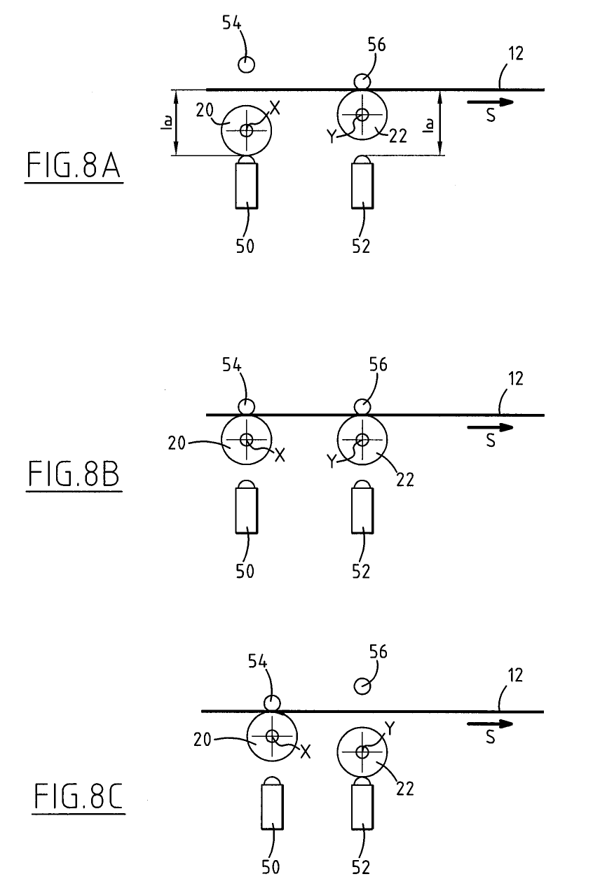

FIGS. 8A to 8C illustrate a sixth embodiment of a traction module 8 according to the invention.

This traction device includes two traction rollers 20, 22 which are arranged only at one side of the printed web 12 one behind the other. The traction device 8 further includes two clamping rollers 54, 56 which are arranged at the other side of the printing web 12 and which have a diameter which is less than the diameter of the traction rollers 20, 22. Each of the clamping rollers 54, 56 is suitable for being applied to the printed web 12.

Each clamping roller 54, 56 is, in conjunction with the associated traction roller 20, 22, suitable for clamping the printed web 12.

The traction rollers 20, 22 are suitable for alternately moving into contact with the printed web 12.

The traction device further includes, for each traction roller 20, 22, a washing device 50, 52. Each washing device 50, 52 is located at a distance a from the surface of the printed web 12 which is greater than the diameter of the associated traction roller 20, 22. When the traction roller 20, 22 is not in contact with the printed web 12, those washing devices 50, 52 wash the surface of the traction roller 20, 22.

FIG. 8A shows the step, in which the traction roller 20 is in the process of being cleaned by the washing device 50. The clamping roller 54 is spaced apart from the surface of the web 12. The traction roller 22 is spaced apart from the washing device 52 and is applied to the surface of the printed web 12. The clamping roller 56 is also applied to the web 12 in such a manner that the web 12 is clamped between the clamping roller 56 and the traction roller 22.

FIG. 8B shows an intermediate step, after the cleaning of the traction roller 20 has finished. During that step, the two traction rollers 20, 22 are in contact with the web 12, and the clamping rollers 54, 56 are also applied to the web.

During a successive step, illustrated in FIG. 8C, the traction roller 20 and the clamping roller 54 are the only elements which clamp the web 12 between them, while the traction roller 22 and clamping roller 56 are not in contact with the web 12, the traction roller 22 being cleaned by the cleaning device 52.

The device described in FIGS. 8A, 8B, 8C has an advantage over the device described in FIG. 6. Supposing that the cleaning may, owing to contamination by the washing solvent, temporarily modify the properties of the surfaces of the rollers 20 and 22 (rejection of ink), this operation is carried out with the cleaning devices 50 and 52 while the traction rollers 20 and 22 are not in contact with the web.

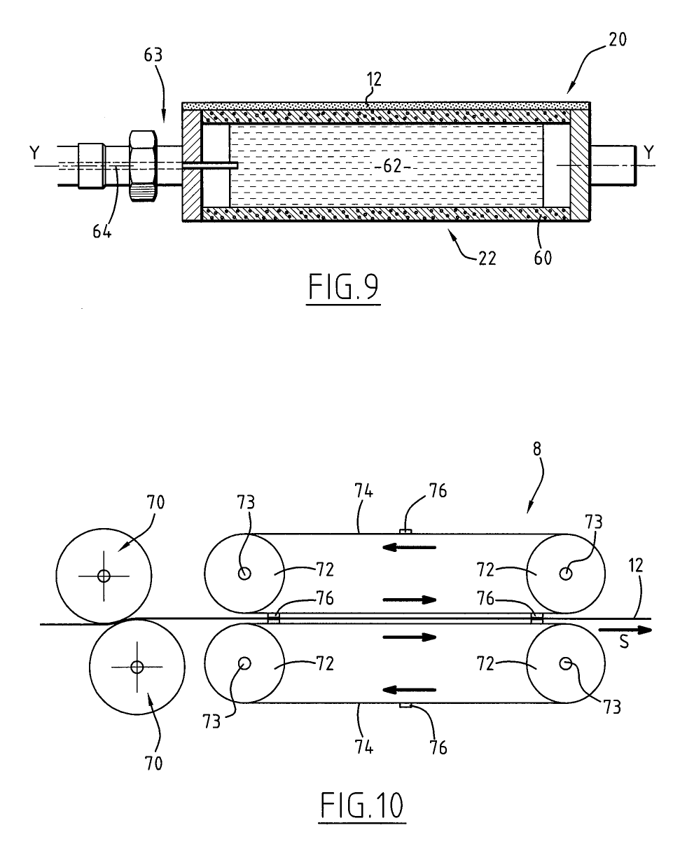

FIG. 9 is a cross-section of a traction roller of a seventh embodiment of a traction module 8 according to the invention. This traction module 8 includes a traction roller 22 which is provided with a porous wall 60 in such a manner as to define a porous traction surface. The pores of the wall 60 are open cells so that a liquid 62 which is provided inside the roller 22 can pass through the wall 60 and move into contact with the printed web 12. The liquid 62 is, for example, a mixture of water and silicone.

Furthermore, the traction roller 22 also includes a rotating joint 63 which includes a central liquid supply 64 which opens inside the traction roller 22. The supply 64 is provided coaxially with respect to the axis Y-Y of the traction roller 22.

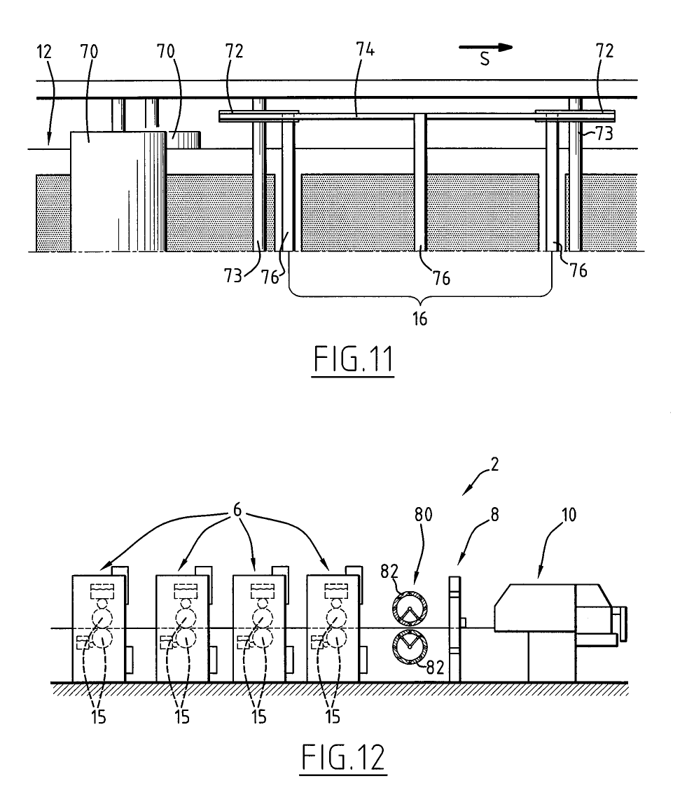

FIGS. 10 and 11 show an eighth embodiment of a traction device 8 according to the invention.

This traction device 8 includes two blanket rollers 70 which are applied, at one side and the other, to the printed web 12 and which are offset from each other in the direction of travel of the web 12.

The traction device 8 further includes eight toothed rollers 72 which are connected, in groups of two, by an axle 73. The traction device 8 is provided with four belts or chains 74, each of which is guided around two toothed rollers 72 which are arranged at only one side of the web 12. The two belts 74 at one side of the printed web 12 are connected by traction bars 76 which are provided at a mutual distance on the belt 74 which corresponds to the length of the web portion 16. The traction bars 76 are suitable for being applied, at one side and the other, to the web 12, facing each other, and for clamping the web therebetween. In this manner, they are suitable for applying traction to the web 12.

Preferably, the bars 76 are moved in synchronism with the web 12 in such a manner that they are applied only to the non-printed zone of the web 12. Furthermore, the surface which moves into contact with the web 12 of the bar 76 is preferably constructed from an elastomer material.

FIG. 12 illustrates part of a variant of a printing press comprising an auxiliary device 80 which is provided between the printing unit 6 furthest downstream and the cutting device 10. In this instance, the auxiliary device 80 is provided upstream of the traction device 8. This auxiliary device 80 includes two support rollers 82 which are provided at one side and the other of the web 12.

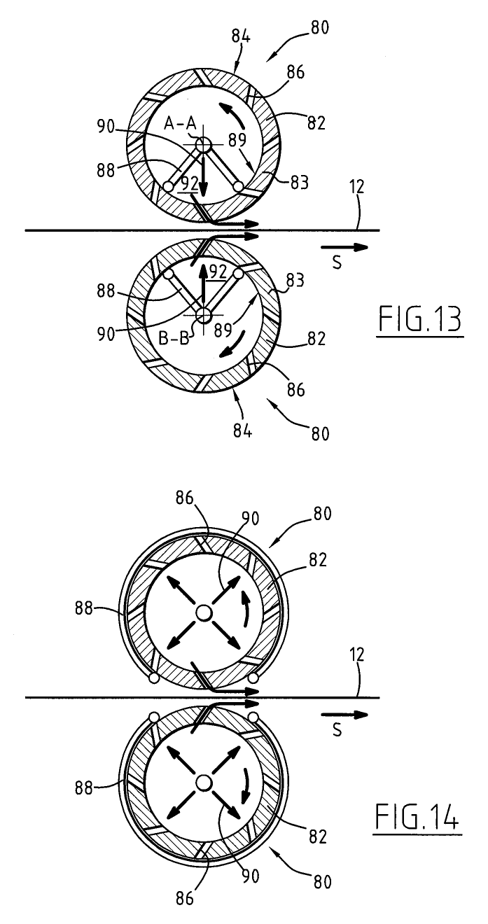

FIG. 13 shows a cross-section of the support rollers 82 to an enlarged scale.

The support rollers 82 are hollow and include a cylindrical wall 83 having an annular cross-section. The wall 83 forms an outer support surface 84. The auxiliary device 80 includes means for producing a cushion of air between the support surface 84 and the printed web 12. Those means for producing a cushion of air include, on the one hand, openings 86 which extend through the wall 83 of the roller 82. Those openings 86 are provided, in cross-section, in a secant-like manner relative to the axis itself A-A, B-B of the roller 82. Furthermore, at a location near the web 12, the openings 86 have a component directed in the movement direction S of the web 12, in the direction radially outwards relative to the axis itself A-A, B-B of the roller 82 in question. Furthermore, the means for producing a cushion of air include two sealing walls 88 which are provided inside each support roller 82, those walls 88 being applied, on the one hand, in an air-tight manner, against the internal surface 89 of the wall 83, and, on the other hand, to the centre axis of the support roller 82. Furthermore, a pressurised air inlet 90 is connected to the chamber 92 which is defined by the walls 83 and 88.

During the operation of this auxiliary device 80, the support rollers 82 are rotated in such a manner that the circumference thereof at a location near the printed web moves in the direction S of travel of the printed web 12. The opening 86, which is at a given time in communication with the chamber 92 defined by the walls 83 and 88, allows air in the chamber 92 to be discharged, and a cushion of air to be produced between the outer surface 84 and the printed web 12, which guides the printed web 12.

FIG. 14 shows a variant of the auxiliary device 80 which differs from the device of FIG. 13 as follows. Similar elements are referred to with the same reference numerals.

This auxiliary device 80 includes a single sealing wall 88 by means of a roller 82, which wall 88 extends around the support roller 82 over practically the entire circumference thereof, with the exception of a portion which is directed towards the printed web 12. No sealing wall extends inside the roller 82. This embodiment is simple to construct.

In a variant which is not illustrated, at least one of the traction rollers 20, 22 includes openings in the outer surface thereof, and the traction device 8 is provided with a pressure reduction device which is suitable for producing a reduced pressure in those openings. This promotes guiding of the web 12.

Generally, the traction elements include traction surfaces which move into contact only with the non-printed zone of the web 12. To that end, the traction elements may include a traction roller which is applied to a lateral, non-printed zone of the web.

What is claimed is:

1-26. (canceled)

27. A rotary printing press comprising:
a continuous printing web of material to be printed;
at least one printing unit for printing on the printing web;
a cutting device for cutting the web printed by the at least one printing unit; and
a traction device downstream of the furthest downstream printing unit and upstream of the cutting device, the traction device for applying a predetermined mechanical tension to the printed web discharged from the furthest downstream printing unit, the printing web being a coated paper web.

28. The printing press according to claim 27, wherein the press conveys the printed web so as to be freely suspended and in ambient air over an entire travel between the furthest downstream printing unit and the traction device.

29. The printing press according to claim 27, wherein the press conveys the printed web in ambient air over an entire travel between the traction device and the cutting device.

30. The printing press according to claim 27, further comprising a dryer for drying the printed web downstream of the traction device and upstream of the cutting device.

31. The printing press according to claim 27, wherein the traction device includes two traction elements, each traction element having a traction surface for moving into contact with a face of the printed web so as to apply the predetermined mechanical traction to the printed web.

32. The printing press according to claim 31, wherein the press includes a dampener for providing a liquid which repels ink at least at one traction surface.

33. The printing press according to claim 31, wherein the two traction elements include traction surfaces which repel ink.

34. The printing press according to claim 31, wherein the two traction elements are traction rollers.

35. The printing press according to claim 34, wherein the two traction rollers are provided with spacing from each other, defining a substantially S-like travel for the printed web.

36. The printing press according to claim 34, wherein the two traction rollers are provided one behind the other over the travel of the printed web, and the traction device includes two clamping rollers each of which is provided facing one of the traction rollers, the clamping rollers having a diameter which is different from the diameter of the traction rollers, and the clamping rollers and the traction rollers being suitable for clamping the printed web therebetween, respectively.

37. The printing press according to claim 34, wherein the two traction rollers are provided facing each other.

38. The printing press according to claim 31, wherein each of the two traction elements is suitable for moving into contact with one of the two opposing faces of the printed web.

39. The printing press according to claim 34, wherein at least one of the traction rollers includes openings in the outer surface thereof, and the traction device includes a pressure reduction device for producing a reduced pressure in those openings.

40. The printing press according to claim 34, wherein the traction device includes a cleaning device for cleaning the traction surface of at least one of the traction rollers.

41. The printing press according to claim 40, wherein the cleaning device includes a cleaning bar in contact with the traction surface.

42. The printing press according to claim 40, wherein the cleaning device includes a first cleaning roller whose surface is suitable for moving into rolling contact with a traction roller and whose surface attracts ink, the cleaning device further includes a doctor blade for removing ink from the surface of the first cleaning roller.

43. The printing press according to claim 42, wherein the cleaning roller is movable between a cleaning position in contact with the associated traction roller and a washing position in contact with a washing device for washing the cleaning roller.

44. The printing press according to claim 42, wherein the cleaning device includes a second cleaning roller for moving into contact with the same traction roller as the first cleaning roller, the two cleaning rollers are suitable for alternately moving into contact with the traction roller.

45. The printing press according to claim 35, wherein the traction device includes a cleaning device for cleaning the traction surface of at least one of the traction rollers, the traction rollers and the clamping rollers being movable between a traction position of the printed web and a cleaning position, the press being suitable for moving a first pair of rollers including a traction roller and a clamping roller into the cleaning position thereof while a second pair of rollers including a traction roller and a clamping roller is in the traction position thereof

46. The printing press according to claim 27, wherein the traction elements include traction bars that extend across the printed web.

47. The printing press according to claim 27, further comprising an auxiliary device between the furthest downstream printing unit and the cutting device, the auxiliary device including at least one support roller provided with a support surface for the printed web, the auxiliary device including device for producing a cushion of air between the support surface and the printed web.

48. The printing press according to claim 27, wherein the printing unit includes a reservoir of ink which contains ink for printing on the printing web.

49. The printing press according to claim 48, wherein the ink is waterless ink.

50. The printing press according to claim 48, wherein the ink is desiccative ink or bi-component ink.

51. The printing press according to claim 27, wherein the coated paper of the printing web includes a coating of kaolin or chalk.

52. A printing method comprising the steps of:
a) printing on a printing web, forming a printed web;
b) cutting the printed web into printed sheets;
c) producing a predetermined mechanical tension in the printed web before the cutting step using the printing press recited in claim 27.

53. The method for printing as recited in claim 52 wherein the coated paper web includes a coating of kaolin or chalk.

54. The printing press as recited in claim 30 wherein the dryer is an infrared radiation drying device.
